(19) United States
(12) Patent Application Publication
(10) Pub. No.: US 2018/0121260 A1
(43) Pub. Date: May 3, 2018

(54) DEFINING VARIABILITY SCHEMAS IN AN APPLICATION PROGRAMMING INTERFACE (API)

(71) Applicant: INTUIT INC., Mountain View, CA (US)

(72) Inventors: Deepak NADIG, Mountain View, CA (US); Jayanth SAIMANI, Bangalore (IN); Rajat KHARE, Bangalore (IN); Vishwanath RANGANATH, Bangalore (IN)

(21) Appl. No.: 15/399,173

(22) Filed: Jan. 5, 2017

(30) Foreign Application Priority Data
Oct. 31, 2016 (IN) 201631037275

(51) Int. Cl. G06F 9/54; G06F 17/30

(52) U.S. Cl. CPC G06F 9/541; G06F 17/30294; G06F 17/30424

(57) ABSTRACT

The present disclosure relates to managing variability in an application programming interface (API). According to one embodiment, a method generally includes receiving, from a user, a definition of a variability schema and context information associated with the variability schema. The variability schema generally represents a variation of one or more properties defined in an application programming interface (API). A computing system links the variation and context information to the one or more properties defined in the API. The computing system receives a query to perform one or more actions using the one or more properties, matches context information associated with the query to the context information associated with the variability schema, and processes the query using the variation of the one or more properties.

### CROSS-REFERENCE TO RELATED APPLICATIONS

This application claims benefit of India Provisional Patent Application Serial No. 201631037275, entitled “Defining Variability Schemas in an Application Programming Interface (API),” filed Oct. 31, 2016, which is assigned to the assignee hereof and the contents of which are hereby incorporated by reference.

### BACKGROUND

### Field

Embodiments presented herein generally relate to supporting variability in an application programming interface (API), and more specifically to defining API function calls using variability schemas associated with a context in which the API function call is invoked.

### Description of the Related Art

Application programming interfaces (APIs) generally expose various routines and methods to software developers for use in obtaining and modifying data using features of a software application. These APIs may be accessible programmatically (e.g., as function calls programmed in an application or function library) or via a web resource for web-based applications. Web-based applications can invoke functionality exposed by an API, for example, using a Representational State Transfer function call (a RESTful function call), queries encapsulated in an HTTP POST request, a Simple Object Access Protocol (SOAP) request, or other protocols that allow client software to invoke functions on a remote system.

In some cases, such as software systems that are used globally and are subject to different operational requirements for different geographical regions in which the software systems are used, the operational requirements for those regions may be hard-coded in application source code. The source code generally uses functionality exposed by the API to retrieve data from a data service and format the data according to rules in the application source code or format data according to the rules and submit the formatted data to the data service to be committed to a persistent data store. For example, in an invoice generation workflow, tax rates applicable to provided goods and services, tax authorities that impose taxes on goods and services, required information in an invoice, and so on may differ based on a jurisdiction in which the organization that generates the invoice is located. As the operational requirements change, parameters in application source code are generally changed to reflect the changed operational requirements (e.g., changes in tax rates, goods and/or services to which tax is applied, changes in tax authorities, and so on). Because changes in operational requirements generally entail changes to application source code, supporting variability in an application may require that developers debug the application source, recompile the application, and provide update packages to application users.

Additionally, to support new variations in a workflow (e.g., new jurisdictions for an invoice generation workflow), developers generally need to generate application source code to support a workflow according to the operational requirements for the new variation of the workflow. Generating new application source code is a time-intensive process and may entail duplicating large amounts of source code. As the number of supported variations of the workflow—and the corresponding code base to support the variations of the workflow—increases, the amount of code to maintain increases. These increases in the amount of code to maintain may increase the amount of work required to maintain and update an application.

### SUMMARY

One embodiment of the present disclosure includes a method for managing variability in an application programming interface (API). The method generally includes receiving, from a user, a definition of a variability schema and context information associated with the variability schema. The variability schema generally represents a variation of one or more properties defined in an application programming interface (API). A computing system links the variation and context information to the one or more properties defined in the API. The computing system receives a query to perform one or more actions using the one or more properties, matches context information associated with the query to the context information associated with the variability schema, and processes the query using the variation of the one or more properties.

Another embodiment provides a computer-readable storage medium having instructions, which, when executed on a processor, performs an operation for managing variability in an application programming interface (API). The operation generally includes receiving, from a user, a definition of a variability schema and context information associated with the variability schema. The variability schema generally represents a variation of one or more properties defined in an application programming interface (API). A computing system links the variation and context information to the one or more properties defined in the API. The computing system receives a query to perform one or more actions using the one or more properties, matches context information associated with the query to the context information associated with the variability schema, and processes the query using the variation of the one or more properties.

Still another embodiment of the present invention includes a processor and a memory storing a program, which, when executed on the processor, performs an operation for managing variability in an application programming interface (API). The operation generally includes receiving, from a user, a definition of a variability schema and context information associated with the variability schema. The variability schema generally represents a variation of one or more properties defined in an application programming interface (API). A computing system links the variation and context information to the one or more properties defined in the API. The computing system receives a query to perform one or more actions using the one or more properties, matches context information associated with the query to the context information associated with the variability schema, and processes the query using the variation of the one or more properties.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates an example computing environment, according to one embodiment.

FIGS. 2A and 2B illustrate example variability schemas for generating invoices using a single code base, according to one embodiment.

FIG. 3 illustrates example relationships between variability schema and context information used to select a variability schema for processing a data query, according to one embodiment.

FIG. 4 illustrates an example configuration engine for defining relationships between variability schema and data objects and functions in an application programming interface (API), according to one embodiment.

FIG. 5 illustrates example operations for establishing a variability schema for interacting with functionality provided by an application programming interface (API), according to one embodiment.

FIG. 6 illustrates an example computing system for establishing variability schemas for interacting with functionality provided by an application programming interface (API), according to one embodiment.

### DETAILED DESCRIPTION

Application programming interfaces (APIs) generally expose methods and procedures that software developers can use to build software applications using features provided by a software system. These features may include, for example, database interaction, data processing, and so on. APIs generally define a set of inputs for an application to provide for processing and a set of outputs generated by the application in response to the inputs. When an application invokes an API function call to retrieve data for display to a user, the application can receive unformatted data (e.g., as a set of strings) and format the strings according to the source code associated with a particular variation of a workflow (e.g., an invoice generation workflow for a particular jurisdiction). When an application invokes an API function call to write data to a data repository, the application can receive unformatted data from a user and verify the data against rules in the source code associated with a particular version of a workflow. If the application determines that the data complies with hard-coded rules in the application source code for a particular version of a workflow, the application can invoke an API function to commit the data to the data repository. Otherwise, based on hard-coded rules in the application source code, the application can generate alerts to inform a user that the inputted data does not comply with the rules established for the version of the workflow.

Variations in a workflow exist for various reasons. In some cases, performing the same task, such as establishing a tax reporting system or generating invoices, may use similar data but differ across different jurisdictions. In another example, a workflow for generating invoices on a per-project basis may differ from a workflow for generating invoices for the sale of goods (e.g., in jurisdictions where taxes are applied to the sale of goods but not to the sale of services). In still further cases, workflows may differ based on a type of user that is interacting with data. For example, the owner of a business may be allowed to create and modify invoices, while external auditors may be granted read-only access to the invoices generated for a predetermined reporting period (e.g., invoices generated during a business's fiscal quarter or fiscal year).

Typically, enabling an application to process multiple variations of a workflow (e.g., generating invoices according to taxation rules for different jurisdictions) involves maintaining independent code bases for each variation of the workflow. As discussed, maintaining independent code bases for each variation of the workflow increases the amount of code to be modified as applications change. Additionally, when the processing rules for a particular variation of a workflow change (e.g., in a taxation example changing the name and applied tax rate of a tax agency), application source code may need to be recompiled, which is a computationally expensive process.

Embodiments of the present disclosure provide techniques for separating variations in processing a workflow from the source code used to process data interactions between a user and a server. By separating variation schema for processing a workflow from the source code itself and including information about a variation in a response to an API call, a single code base can be used for software applications that execute a given workflow regardless of the workflow variation each user uses. Additionally, as the operational parameters and requirements for a codebase changes, the underlying source code for processing a transaction (e.g., invoking and processing a read or write request using an API function) need not change to reflect, for example, updated or new rules for processing the request.

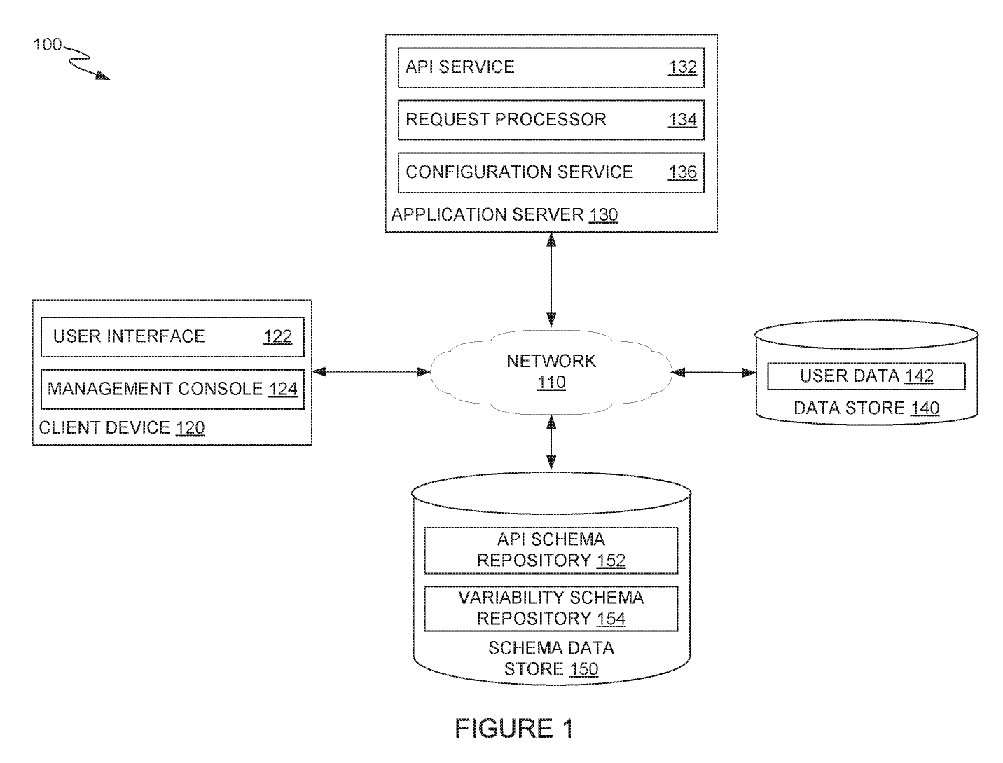

FIG. 1 illustrates an example computing environment for defining variability schemas in an application programming interface (API), according to some embodiments. As discussed, the variability schemas defined for an API allow a single code base to be used for processing data transactions using functionality exposed by the API. As illustrated, computing environment 100 includes a client device 120, an application server 130, a user data store 140, and a schema data store 150.

Client device 120 generally includes a user interface 122 and a management console 124. User interface 122 allows users to interact with data and services provided by a software system (e.g., via a graph-based API). User interface 122 generally displays graphical user interface (GUI) elements that allow a user to interact with an application hosted on application server 130. In an example, user interface 122 may allow a user to select data that the user wishes to view. Based on the selections received in user interface 122, client device 122 generates and transmits a query to application server 130. In some cases, the query may include information that application service 130 can use to determine a context of the query and retrieve a relevant variability schema to use in processing an API function call. For example, the query may include information about the user that is attempting to interact with application server. The user information may include, for example, information about a location of the user (e.g., to retrieve the proper data processing rules from schema data store 150 for a particular location or jurisdiction), an identity of the user (e.g., membership within defined security groups for which access to certain types of data is allowed or blocked), and so on.

In response to a query, user interface 122 generally receives data from application server 130 and information about a variability schema to apply to the data displayed in user interface 122. The information about a variability schema to apply to the data displayed in user interface 122 can be used, for example, to determine types of user interface components to display to a user. If the variability schema identifies that data retrieved from application server 130 should not be visible to a user, user interface 122 can skip rendering a user interface element for those data items. Otherwise, user interface 122 can determine a type of form element to display to a user. If the variability schema indicates that a field is changeable, user interface 122 can display a text entry box to allow a user to modify the contents of the field. If the variability schema indicates that a field is selectable and that the field only accepts a single selection, user interface 122 can display a series of option buttons (or radio buttons) that allows a user to select a single operation from a list of options presented in user interface 122. If the variability schema indicates that a field supports selection of multiple operating parameters, user interface 122 can display the field as a series of checkboxes or other user interface element that allows for the selection of multiple options from a list.

Management console 124 allows a user to add variability schemas to variability schema repository 154 and edit existing variability schemas defined for an application executing in application server 130 based on changes outside of computing environment 100. For example, if a new tax authority is introduced in a jurisdiction, a user can edit the variability schema associated with an invoice generation workflow for that jurisdiction in management console and commit the updated variability schema to variability schema repository 154. Management console 124 may be, for example, a text editor that retrieves a variability schema from variability schema repository 154 in schema data store 150 and displays the text of the variability schema to a user for editing. In some cases, management console 124 may provide a graphical interface to allow a user to select new operational parameters associated with a variability schema (e.g., to enable the display of a previously hidden field in user interface 122).

Application server 130 generally includes an API service 132, a request processor 134, and a configuration service 136. API service 132 receives a query from a client device 120 and parses the request to identify one or more systems that should process different parts of the request. In some cases, the query from client device 120 may include a request for properties of the requested data. The properties of the requested data may be defined in a variability schema associated with the context of the query (e.g., user location, data access permissions associated with the user, and so on).

In some cases, the query received from client device 120 can include context information that API service 132 can use to obtain a variability schema for use in processing the query. The context information may be provided to API service 132, for example, in the header of an HTTP request (with the query provided to API service as a RESTful query or in an HTTP POST method) or otherwise based on information identifying the user that generated the query. In some cases, the context information can include a user identifier that API service 132 can use to determine context information for obtaining a variability schema to use in processing the request. For example, API service 132 can use a user identifier to query a data service for information about user location, group membership, or other data that API service can use to find a variability schema to use in processing the query.

After determining the context associated with a query, API service 132 provides the query and variability schema to request processor 134 for processing. Based on the query received from API service 132, request processor 134 can execute a query on user data 152 in data store 150 for the requested data. In some cases, request processor 134 may additionally include other logic for processing the requested data before transmitting the requested data and the variability schema to client device 120 for display in user interface 122.

Configuration service 136 generally receives variability schema definitions, which represent variations of one or more properties (e.g., data objects models or function calls) defined in an API, from management console 124 and links the received variability schema to the one or more properties. To add a variability schema to the API, configuration service 136 receives the variability schema and context information from a client device 120. Based on the contents of the variability schema, configuration service 136 determines whether the variability schema modifies the operations of an existing workflow in the API or adds a custom workflow to the API.

If configuration service 136 determines that a received variability schema modifies the operations of an existing workflow in the API for a given context (location, group of users, and so on), configuration service 136 can commit the variability schema to variability schema repository 154 with information about the context in which the workflow defined by the variability schema will be invoked. Subsequently, when a user invokes an API call with a context matching the context associated with the received variability schema, API service 132 and request processor 134 can use the received variability schema to process data retrieved from and/or transmitted to a data store 140.

Otherwise, if configuration service 136 determines that a received variability schema represents an extension to the API (e.g., a new data object model definition and corresponding schema defining rules for interacting with the new data object), configuration service 136 can add the new data object to the API. Configuration service 136 additionally commits the variability schema defining the rules for interacting with the new data object to variability schema repository 154 in schema data store 150.

Data store 140 generally is a repository storing data that request processor 134 can access to satisfy requests for data received at application server 130. As illustrated, data store 140 generally includes user data 142 in a sortable and searchable state. In response to a query received from request processor 134 at application server 130, data store 140 can return a set of data matching the parameters included in the request, and request processor 134 may perform additional processing on the returned data before providing the data to a client device 120 via API service 132.

Schema data store 150 generally is a repository for storing schema definition files for each node, or query, available in an API and variability schemas describing processing rules for different workflows that can be executed on application server 130. As illustrated, schema data store 150 includes API schema repository 152 and variability schema repository 154.

Data stored in API schema repository 152 may define one or more functions provided by the API. As developers create API extensions through an API extender, files defining these API extensions may be committed to API schema repository 152. In some cases, schema data store 150 may also store a graph projection of the API, including extensions added to the API by various developers.

API schema repository 152 may additionally include data object models that define information available in the API that can be encapsulated in a data object and provided to client device 120 in response to a data request received from client device 120. For each data field enumerated in the data object, the API schema file includes metadata that indicates the properties of the data field. The properties can include, for example, at least the name of the data property and a data type (e.g., string, integer, single precision floating point number, double precision floating point number, and so on). Data object models may be stored in API schema repository 152 as a series of markup files associated with a base data object.

Variability schema repository 154 generally includes schema files that define variations on a workflow that can be executed by application server 130. The schema files may include markup files or structured data files that define variations in workflow behavior relative to a base or default workflow, such as a YAML (Yet Another Markup Language) file, an XML (Extensible Markup Language) file, and so on. As discussed, the variability schema can define extensions to a data object model and operations that a user can perform with respect to data defined by a data object model in API schema repository 152. When a system administrator identifies variants of a workflow to add to the API, the system administrator can generate a schema file defining a variation of a workflow with references to the one or more data objects that the workflow will use. In some cases, the variability schema can define additional properties to apply to data fields enumerated in a data object used by the workflow variant. For example, the variability schema can include processing rules that define a valid (or invalid) string input for a data field defined in a data object. The processing rules may be structured, for example, as a set of regular expressions that define the format of a string stored in data store 140 and used by the API, minimum and maximum values for numerical data, and so on

In some cases, the variability schemas can define rules for processing data included in a data object. For example, in an invoice generation workflow, different variability schemas can define rules for calculating taxes to apply to an invoice based on a jurisdiction of the user that generates the invoice. Variability schemas associated with different jurisdictions can include processing rules for calculating the amount of tax payable to each tax authority in a given jurisdiction. A variability schema for a first jurisdiction with a national and local sales tax may define tax rates to be paid for goods provided by the seller, while a variability schema for a second jurisdiction with a national goods and services tax may define a single tax rate to be paid for goods or services provided by the seller.

In some cases, variability schemas may exist for processing data based on a role of a user in an organization (e.g., roles determined by membership in an access group). In an invoice generation workflow, for example, some classes of users may need to be able to generate, edit, and view invoices (e.g., users who are a member of a billing/accounting group within an organization), while other classes of users may only need to be able to view invoices (e.g., external auditors who cannot generate invoices but may need to view invoices during the audit process). To allow for the use of a single code base to process data queries for different groups of users, variability schemas may be defined for different users or groups of users. These variability schemas can define the data that each type of user can access, whether a particular group of users has permission to write or edit certain types of data, and so on.

In some cases, variability schemas may be used to extend data objects defined in the API. In some cases, the variability schemas may be used to define custom data fields in a data object and the policies associated with the custom data fields. The custom data fields may be associated with a particular user or set of users, which allows groups of users to interact with user-specific extensions to the API that may not be usable by users or groups of users outside of a defined group. For example, a default invoice generation workflow may implement a set of rules to obtain transaction information and customer information from data store 140. Variability schemas for generating invoices in different jurisdictions may extend the default invoice generation workflow to include additional information in an invoice data object model. For example, a variability schema for one jurisdiction may add value added tax (VAT) numbers for both the purchaser and seller into the data object model for an invoice and may additionally specific processing rules for determining the validity of a VAT number. In another jurisdiction, the variability schema may add itemized taxation fields (e.g., on a per-taxation-authority basis) to an invoice data object model.

The variability schemas stored in variability schema repository 154 are generally associated with data that identifies when API service 132 would select a particular variability schema for use in processing a query received from client device 120. A variability schema may be associated with, for example, a geographical location, a group of users, and so on. As discussed, when a user generates a query for processing at application server 130, API service 132 can identify a context associated with the query and obtain the matching variability schema for the query. By obtaining a matching variability schema for the context of the query, API service 132 can use a single interpreter to parse the variability schema and requested data into usable data that can be, for example, displayed in user interface 122 for a user to interact with (view, modify, delete, and so on).

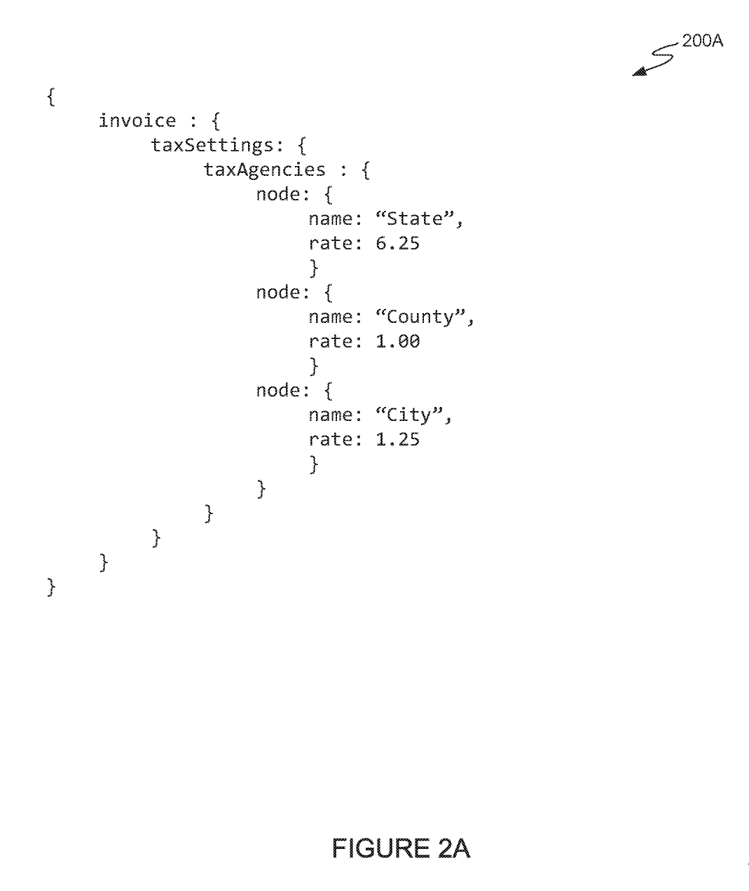

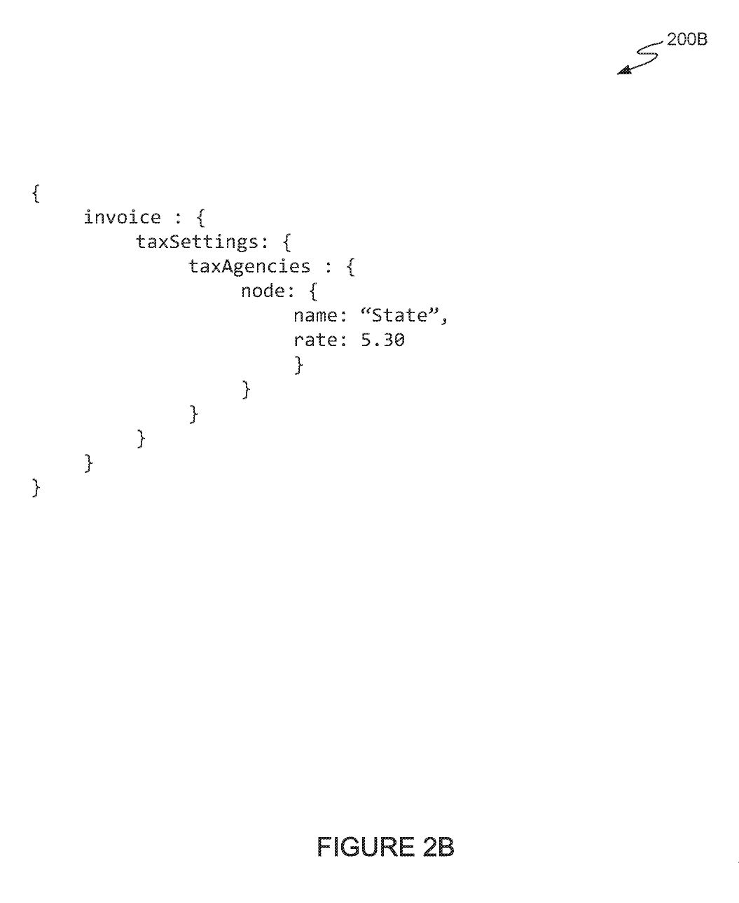

FIGS. 2A and 2B illustrate different variability schemas associated with an invoice generation workflow, according to some embodiments. These variability schemas include rules that define the invoice generation workflow for different contexts in which the workflow is invoked (e.g., where invoices are generated by users in different jurisdictions with different taxation rules, formatting rules, and so on).

Variability schema 200A illustrates the tax rates to be applied to an invoice generated for transactions performed in a first jurisdiction. As illustrated, invoices generated for transactions performed in the first jurisdiction are subject to state, county, and city tax. When a user generates an invoice using variability schema 200A, a user invokes an invoice generation function provided by the API and provides an identifier of at least one transaction for which application server 130 should generate an invoice. API service 132 can determine that that the user is attempting to invoke an invoice generation function and that the user is located in a geographical area associated with variability schema 200A (e.g., based on geographical location information associated with the user or group of users in a database). For each transaction, request processor 134 can apply the rules defined in variability schema 200A to add three tax items to the invoice: state tax of 6.25% of the pre-tax transaction amount, county tax of 1.00% of the pre-tax transaction amount, and city tax of 1.25% of the pre-tax transaction amount.

Variability schema 200B illustrates the tax rates to be applied to an invoice generated for transactions performed in a second jurisdiction. As illustrated, invoices generated for transactions performed in the second jurisdiction are only subject to state tax. When a user generates an invoice using variability schema 200B, a user invokes an invoice generation function provided by the API and provides an identifier of at least one transaction for which application server 130 should generate an invoice. API service 132 can determine that that the user is attempting to invoke an invoice generation function and that the user is located in a geographical area associated with variability schema 200B. Based on determining that a user has invoked an invoice generation function and should use the rules defined in variability schema 200B, request processor 134 can apply the rules defined in variability schema 200B to add a single sales tax line item to the invoice: a state tax line item of 5.3%.

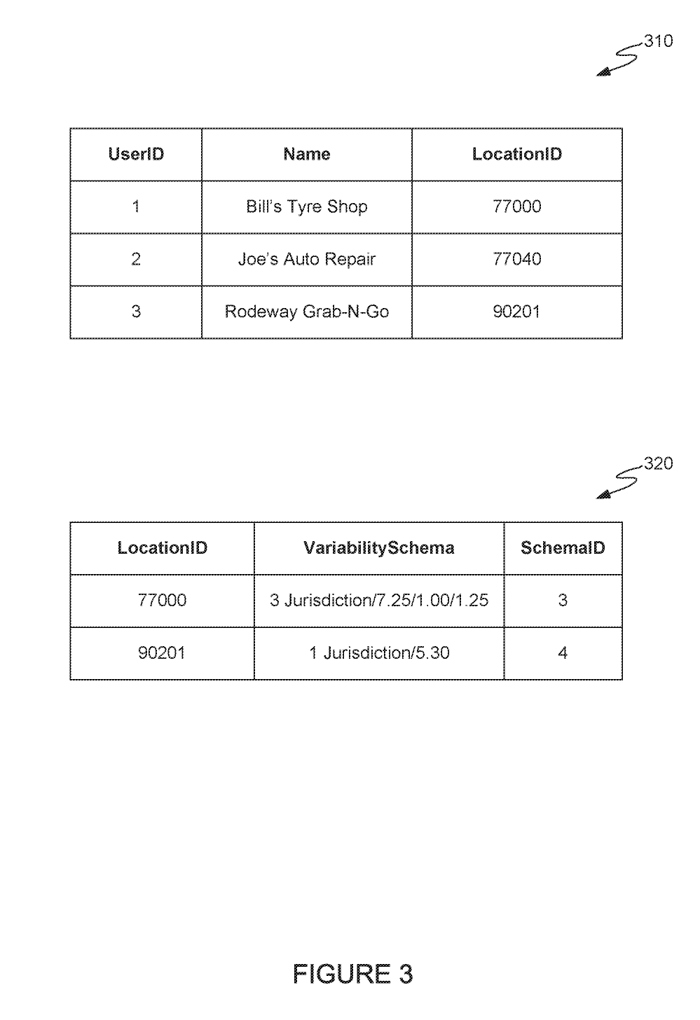

FIG. 3 illustrates an example relationship between user information and variability schema, according to one embodiment. As illustrated, user data may be stored in a user database table 310, and links or references to variability schemas may be stored in a variability schema database table 320.

User database table 310, as illustrated, includes a user ID field, a description field, and a location field. The location field may identify, for example, a postal code associated with the user or other location data from which API service 132 can derive context information for use in processing a query. When a user invokes an API function call, API service 132 can identify the user and, based on the information about the user, query user database table 310 for location information and other context information (e.g., group membership). As discussed, API service 132 can subsequently use the identified context information to identify a variability schema to use in processing a query.

Variability schema database table 320 generally associates variability schemas to context information (e.g., location information, applicable groups, and so on) for API service 132 to use in obtaining a variability schema to use in processing a query. In some cases, variability schema database table 320 may associate context information with the contents of a variability schema. When API service 132 queries variability schema database table 320 for the variability schema associated with an invoked function and user context, variability schema database table can return the variability schema as a plaintext response. In some cases, variability schema database table 320 may associate context information with a link to a variability schema file. In response to a query from API service 132 for a variability schema, variability schema database table 320 can provide the link to the schema to API service 132, which then uses the link to obtain the variability schema (e.g., from a remote data store).

Assume, for example, that user 1 wants to generate one or more invoices for customer transactions that occurred over a set period of time. User 1 can log into application server 130 and invoke an invoice generation function with a list of transactions for which application server 130 should generate invoices. When user 1 invokes the invoice generation function, user 1 transmits identifying information (e.g., a user identifier) with the request to invoke the invoice generation function. Based on the identifying information transmitted with the request to invoke the invoice generation function, API service 132 at application server 130 can query user database table 310 for additional context information. As illustrated, the additional context information may include a postal code associated with the user (in this case, the postal code of “77000”).

After API service 132 obtains the context information associated with the query (or the user that generated the query), API service 132 can search variability schema database table 320 for the variability schema to apply while processing the query. As illustrated, based on the location ID associated with the user, a query for the variability schema would return a schema identifier of “3.” API service 132 can perform additional database queries to obtain the variability schema file associated with the schema identifier of “3.” Once API service 132 retrieves the appropriate variability schema file, request processor 134 can perform the requested function using the retrieved variability schema file.

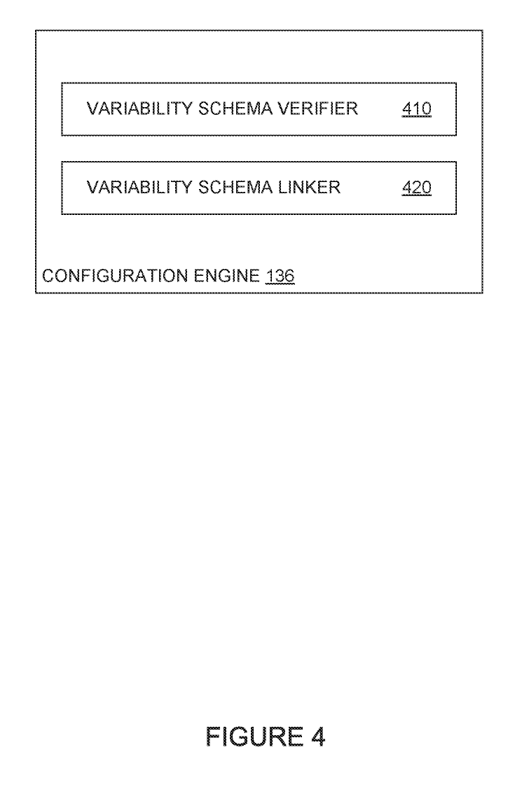

FIG. 4 illustrates an example API configuration service 136, according to one embodiment. As illustrated, configuration service 136 includes a variability schema verifier 410 and a variability schema linker 420. As discussed above, API configuration service 136 allows a developer to introduce new variability schemas into an API to define rules for processing data for a new variation of a workflow.

Variability schema verifier 410 generally examines the received variability schema to determine if the variability schema extends a data object, defines a new data object and a workflow for processing the new data object, defines a new variation for processing a workflow, and so on. In some cases, if the received variability schema extends a data object, variability schema verifier 410 can pass the variability schema to variability schema linker 420 to be committed to schema data store 150.

Variability schema linker 420 can use the information indicating that a received variability schema extends an existing data object to modify the data object in API schema repository 152. For example, if a variability schema adds fields specific to a jurisdiction (e.g., purchaser and buyer VAT numbers in an invoice data object) that need not be used to generate invoices in other jurisdictions, variability schema linker 420 can insert the new fields into the data object model with an indication that the newly added fields are optional fields in the data object.

If the received variability schema defines a new variation for processing a workflow, variability schema verifier 410 can identify the workflow (e.g., an API function invoked by the new variation of the workflow) and the context in which a user would invoke the new variation for processing a workflow. Based on the identified parent workflow variant, variability schema linker 420 can generate an entry in variability schema repository 154 identifying the function(s) invoked by the new variation of the workflow, a context in which API service 132 would execute the new variation of the workflow, and a variability schema corresponding to the new variation of the workflow.

In some cases, the received variability schema may define new data objects and workflows in the API. If variability schema verifier 410 determines that a variability schema does not extend an existing data object or workflow, variability schema verifier 410 can determine that the schema introduces new functionality into the API. Variability schema linker 420 can commit the received variability schema to API schema repository 152 as a “base” or “default” data object model and/or workflow. Subsequent extensions to the “base” data object model and/or workflow can be committed to variability schema repository 154 with context information identifying when API service 132 would invoke the extensions to the “base” data object model or workflow, as discussed above.

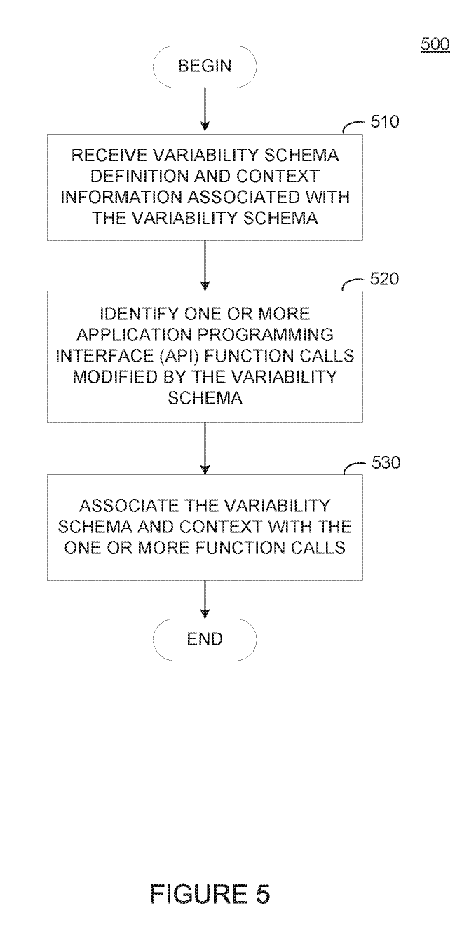

FIG. 5 illustrates example operations that may be performed by a configuration service to add variability schemas to an existing API, according to an embodiment. As discussed herein, by adding variability schemas to an existing API, software developers can add functionality to an existing API (e.g., changes in data processing rules, extensions to data object models, and so on) without generating new source code to implement new functionality.

As illustrated, operations 500 begin at step 510, where configuration service 136 receives a variability schema definition and context information associated with the variability schema. The context information associated with the variability schema may indicate when API service would invoke a workflow associated with the received variability schema (e.g., user location, group membership, and so on).

At step 520, configuration service 136 identifies one or more application programming interface (API) function calls modified by the variability schema. At step 530, configuration service 136 associates the variability schema and context with the one or more function calls. To associate the variability schema and context with the one or more function calls, configuration service 136 can, for example, write an entry in a variability schema repository indicating that a variant of the invoked API function, represented by the variability schema, should be used if the user context matches the context in variability schema repository 154 for the variant of the invoked function. As discussed above, by associating a variability schema with context information for a workflow defined in an API, application server 130 can use a single source code base to process data for any number of variations on a base workflow.

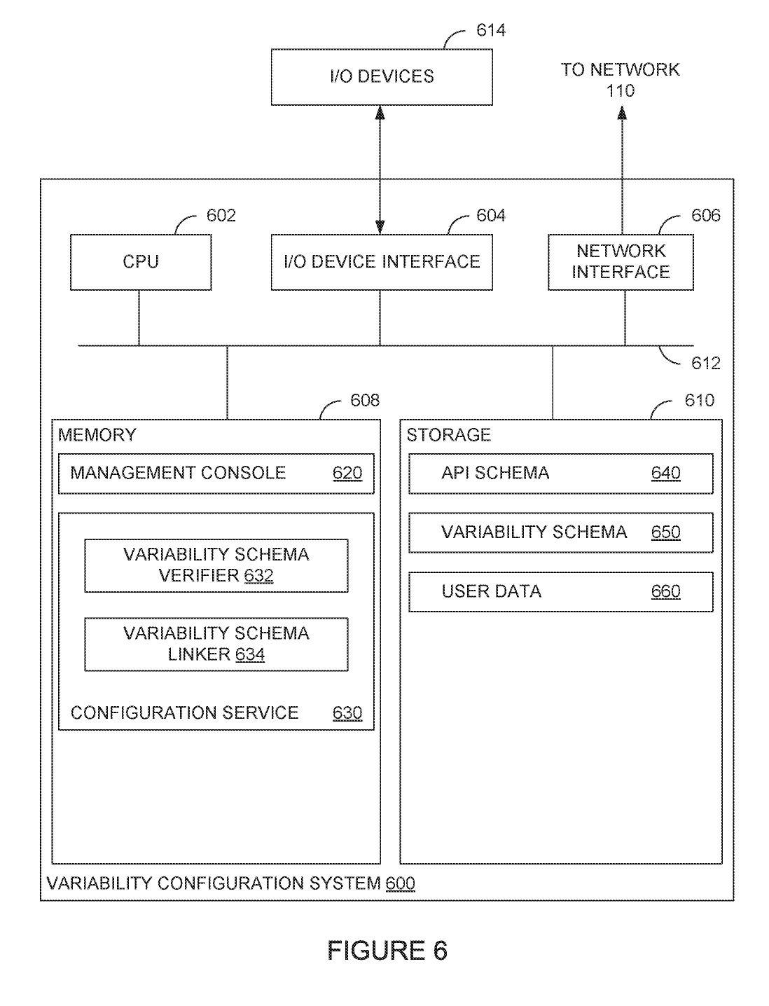

FIG. 6 illustrates an variability configuration system 600 that uses associations between user context and variability schemas to process application programming interface (API) function calls using a single code base, according to an embodiment. As shown, the system 600 includes, without limitation, a central processing unit (CPU) 602, one or more I/O device interfaces 604 which may allow for the connection of various I/O devices 614 (e.g., keyboards, displays, mouse devices, pen input, etc.) to the system 600, network interface 606, a memory 608, storage 610, and an interconnect 612.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, memory 608, and storage 610. CPU 602 is included to be representative of a single CPU, multiple CPUs, a single CPU having multiple processing cores, and the like. Additionally, the memory 608 is included to be representative of a random access memory. Furthermore, the storage 610 may be a disk drive, solid state drive, or a collection of storage devices distributed across multiple storage systems. Although shown as a single unit, the storage 610 may be a combination of fixed and/or removable storage devices, such as fixed disc drives, removable memory cards or optical storage, network attached storage (NAS), or a storage area-network (SAN).

As shown, memory 608 includes a management console 620 and a configuration service 630. Management console 620 generally provides a user interface that a developer can use to generate variants of an API function call or data objects. The variants of an API function call or data object may be defined as a variability schema that extends or otherwise modifies an existing API function call or data object. In some cases, management console 620 may allow a developer to define new functionality in the API and subsequently define variants of that functionality. Developers may identify a context for each variability schema generated in management console 620. As discussed above, the context information, which may include information such as a location of a user, membership in a user group, and so on, is used to determine when an API service invokes a default version of an API function call or a variant of the API function call.

Configuration service 630 generally receives context information and a variability schema from management console 620 to generate an API function call variant that a request processor can use to execute an invoked API function call, according to an embodiment. As illustrated, configuration service 630 includes a variability schema verifier 632 and a variability schema linker 634. Variability schema verifier 632 generally receives a variability schema definition from management console 620 and determines if the variability schema definition is an extension to an existing data object model or function call in the API. If the variability schema definition indicates that the variability schema extends a data object model, variability schema verifier 632 can pass the variability schema to variability schema linker 634 to update the data object model. In some cases, if the variability schema definition indicates that the variability schema implements a variant of an existing API function call, variability schema verifier 632 passes the context information and variability schema to variability schema linker 634 to commit to a variability schema repository.

Variability schema linker 634 generally uses information about a variability schema and context information received from variability schema verifier 632 to commit variations to data object models and/or API function calls to a repository. When variability schema linker 634 commits a variability schema to a repository (e.g., variability schema 650 in storage 610), variability schema linker 634 makes the variation of the data object model and/or API function call available for use by applications interacting with the API. As discussed, variability schema linker 634 can use a variability schema that extends a data object model to edit the data object model with one or more new data fields that may be marked as optional fields. Variability schemas may additionally implement a variation of one or more API function calls. To make these API function call variants available for use by programs interacting with the API, variability schema linker 634 can commit information about the function call variants and a context in which the variants would be invoked to a variability schema repository.

As shown, storage 610 includes API schema 640, variability schema 650, and user data 660. API schema 640 generally provides a data store that includes schema definition files for each of the nodes in a graph projection of the API. As developers add extensions to the API, additional schema definition files may be committed to API schema 640. In some cases, API schema 640 can additionally store a graph projection of the API, which may be updated over time as developers add extensions to the API.

Variability schema 650 generally provides a data store that includes variability schema definitions and associations between variability schemas and user context. As discussed herein, variability schema 650 may be maintained in a relational database that associates context information with a variability schema. An API service can use the context information as a key to identify, for example, a variant of an API function to execute when an API service receives a query from a user.

User data 660 generally includes data that application gateway system stores for an application and can provide in response to a query received at a request processor. User data 660 may be maintained, for example, in a relational database, and a request processor can execute database queries on user data 660 based on the parameters included in the query and formatted according to a variability schema associated with the invoked API function call. In some cases, user data 660 may be maintained in a non-relational data store, and request processor can generate queries for user data 660 based on, for example, key-value pairs or other data points.

Advantageously, by decoupling source code from variations in processing data, developers can maintain a single code base for a software system. Updates and changes to the rules used to process data may be performed by editing a variability schema that the source code processes to identify the data processing rules to apply when executing API function calls. Because the source code to process data according to a variability schema need not change, developers need not spend time editing, debugging, and deploying new versions of a software application in response to changes in the operating parameters for a workflow. Additionally, by decoupling source code from variations in data processing, developers can reduce an amount of code duplication present in application source code, which may aid in source code readability and maintainability.

Note, descriptions of embodiments of the present disclosure are presented above for purposes of illustration, but embodiments of the present disclosure are not intended to be limited to any of the disclosed embodiments. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program.

While the foregoing is directed to embodiments of the present disclosure, other and further embodiments of the disclosure may be devised without departing from the basic scope thereof, and the scope thereof is determined by the claims that follow.

What is claimed is:

1. A method for managing variability in an application programming interface (API), comprising:
receiving, from a user, a definition of a variability schema and context information associated with the variability schema, the variability schema representing a variation of one or more properties defined in an application programming interface (API);
linking the variation and context information to the one or more properties defined in the API;
receiving a query to perform one or more actions using the one or more properties;
matching context information associated with the query to the context information associated with the variability schema; and
processing the query using the variation of the one or more properties.

2. The method of claim 1, wherein the one or more properties comprises a data object model defined in the API.

3. The method of claim 2, wherein the variation comprises one or more additional data elements not present in data object model defined in the API.

4. The method of claim 1, wherein the one or more properties comprises a function defined in the API.

5. The method of claim 4, wherein the variation comprises one or more data processing rules not present in the function defined in the API.

6. The method of claim 1, wherein the context information comprises a geographical location associated with a user that generated the query.

7. The method of claim 1, wherein the context information comprises user membership in an access group and wherein membership in the access group identifies whether the user can invoke one or more functions in the API for modifying data stored in a user data store.

8. The method of claim 1, wherein the definition of the variability schema is included in a markup language file.

9. A system, comprising:
a processor; and
memory storing instructions which, when executed on one or more processors, performs an operation for managing variability in an application programming interface (API), the operation comprising:
receiving, from a user, a definition of a variability schema and context information associated with the variability schema, the variability schema representing a variation of one or more properties defined in an application programming interface (API);
linking the variation and context information to the one or more properties defined in the API;
receiving a query to perform one or more actions using the one or more properties;
matching context information associated with the query to the context information associated with the variability schema; and
processing the query using the variation of the one or more properties.

10. The system of claim 9, wherein the one or more properties comprises a data object model defined in the API.

11. The system of claim 10, wherein the variation comprises one or more additional data elements not present in data object model defined in the API.

12. The system of claim 9, wherein the one or more properties comprises a function defined in the API.

13. The system of claim 12, wherein the variation comprises one or more data processing rules not present in the function defined in the API.

14. The system of claim 9, wherein the context information comprises one or more of:
a geographical location associated with a user that generated the query; and
user membership in an access group, wherein membership in the access group identifies whether the user can invoke one or more functions in the API for modifying data stored in a user data store.

15. A computer-readable medium comprising instructions which, when executed on one or more processors, performs an operation for managing variability in an application programming interface (API), the operation comprising:
receiving, from a user, a definition of a variability schema and context information associated with the variability schema, the variability schema representing a variation of one or more properties defined in an application programming interface (API);
linking the variation and context information to the one or more properties defined in the API;
receiving a query to perform one or more actions using the one or more properties;
matching context information associated with the query to the context information associated with the variability schema; and
processing the query using the variation of the one or more properties.

16. The computer-readable medium of claim 15, wherein the one or more properties comprises a data object model defined in the API.

17. The computer-readable medium of claim 16, wherein the variation comprises one or more additional data elements not present in data object model defined in the API.

18. The computer-readable medium of claim 15, wherein the one or more properties comprises a function defined in the API.

19. The computer-readable medium of claim 18, wherein the variation comprises one or more data processing rules not present in the function defined in the API.

20. The computer-readable medium of claim 15, wherein the context information comprises one or more of:
a geographical location associated with a user that generated the query; and
user membership in an access group, wherein membership in the access group identifies whether the user can invoke one or more functions in the API for modifying data stored in a user data store.
